(19) United States
(12) Patent Application Publication
(10) Pub. No.: US 2006/0031461 A1
(43) Pub. Date: Feb. 9, 2006

(54) Deferred method of sending information

(76) Inventors: Harish C. Mathur, Tucson, AZ (US); John T. Olson, Tucson, AZ (US)

Correspondence Address: QUARLES & BRADY STREICH LANG LLP, 1 SOUTH CHURCH AVENUE, SUITE 1700, TUCSON, AZ, 85701, US

(21) Appl. No.: 10/845,750

(22) Filed: May 14, 2004

(51) Int. Cl. G06F 15/173

(52) U.S. Cl. 709/224

(57) ABSTRACT

A status information tracking system is used to detect anomalous conditions in a monitored system, generate error messages representative of the anomalous conditions, and determine whether the error messages should be transmitted to a remote monitoring station or queued for transmission at a later, more convenient, time. In this manner, non-critical repairs to equipment may be deferred until scheduled service periods thereby increasing service technician efficiency and lowering repair costs.

### BACKGROUND OF THE INVENTION

1. Field of the Invention

This invention is related in general to the field of information handling systems. In particular, the invention consists of a status information reporting method used to defer the transmission of status information until a convenient time for receiving and responding to the status information.

2. Description of the Prior Art

Information handling systems, such as computer servers and computer data libraries, dynamically generate status information that may be transmitted to other locations or a central monitoring station. This status information may include an indication of the condition of the information handling system. When an anomalous condition occurs, the transmitted status information may also include an error message.

The transmitted status information may be monitored by a user or even a computer processing device programmed to detect and respond to anomalous conditions. These monitoring programs traditionally include a procedure for correcting the underlying condition that generated the error messages. For example, an error message received from a computer data library may lead the monitoring program to alert a customer engineer that service on the equipment is required. Depending on the amount of information provided by the error message and the modus operandi of the company providing repair services, the customer engineer may have no choice but to address the reported problem as soon as possible. Often, this will result in service personnel being dispatched to remote service locations at inconvenient times, such as the middle of the night. These inconveniently timed dispatches usually result in a highly inefficient use of customer engineers' time and a corresponding increase in costs.

Based on the amount of information provided by the information handling system, it is common for a customer engineer to arrive at a repair location only to find that the equipment has a minor problem and is, in fact, operating within acceptable parameters. These types of service calls are best addressed during more convenient periods of time such as scheduled maintenance windows. Accordingly, it would be advantageous to have a method of queueing error messages until a convenient period of time.

In U.S. Pat. No. 5,892,898, Toshihisa Fujii et al. disclose an event management system and a storage media for identifying and logging event information. The event management system and the storage media include an application for reporting an event message in response to an occurrence of a particular event and an event logging routine for identifying the source of the error message during a period of time in which the particular event occurred. Using a system similar to that disclosed by Toshihisa, error messages may be queued at the monitoring station until a scheduled maintenance window. However, Toshihisa does not address queueing error messages at the source of error generation. Accordingly, it would be advantageous to have a system that queues status information, especially error messages, until a period of time during which a response to the status information is more convenient. Additionally, it would be advantageous to have a system that generates status information from more than one time zone but delivers the information during a time period standardized by the monitoring station.

### SUMMARY OF THE INVENTION

The invention disclosed herein is a status information tracking system that queues status information until a convenient period of time. This queued status information may include error messages representative of anomalous system conditions such as those that may occur in information handling systems. The queued status information may be transmitted to a remote monitoring location where a user or programmed processing device initiates remedial action in response to error messages. This remedial activity may include dispatching service technicians to repair system equipment.

One aspect of this invention is that windows of time for receiving status information must be specified for various levels of importance or urgency. Generated status information is then given a value corresponding to the importance or urgency of the information and a matching service is used to determine which information should be transmitted during each reception window.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1 is a block diagram of a status information tracking system in accordance with the invention including a status information generating unit, a queueing device, a matching service device, a data transmission device, and a monitoring station.

FIG. 2 is a block diagram of the monitoring station of FIG. 1 including a receiving unit, reception windows, and an optional response unit.

FIG. 3 is a block diagram of one embodiment of the status information tracking system of FIG. 1.

FIG. 4 is a flow-chart illustrating the process of defining reception windows, generating status information, queueing status information, matching queued information to predefined reception windows, and transmitting matched status information to a monitoring station.

### DESCRIPTION OF THE PREFERRED EMBODIMENTS

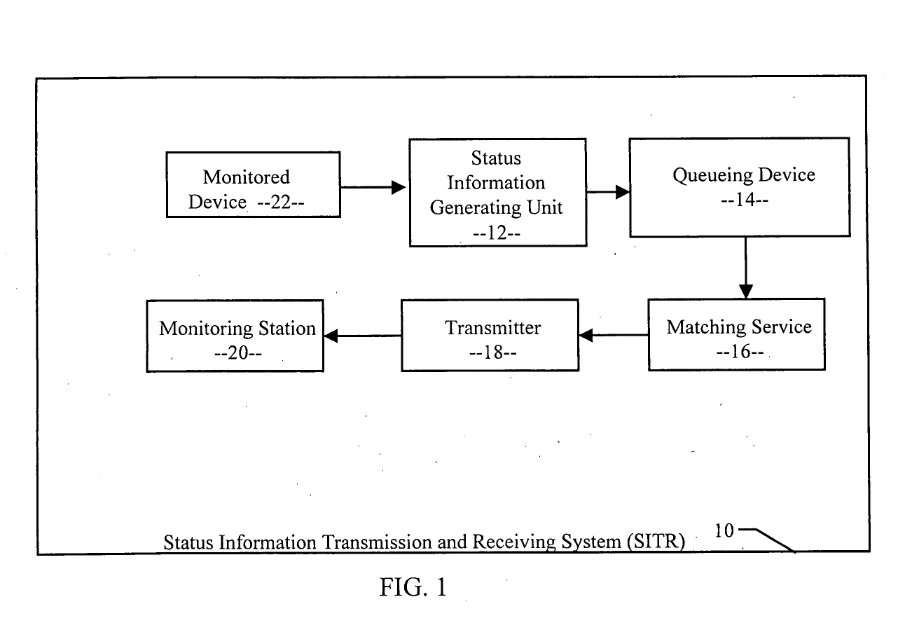

This invention is based on the idea of using a status information tracking system (SITS) to specify reception windows according to importance or urgency, generate and store status information, match the stored information to a corresponding reception window, and transmit the matched information to a monitoring station for possible remedial action. Referring to the figures, wherein like parts are designated with the same reference numerals and symbols, FIG. 1 is a block diagram illustrating a SITS system 10 including a status information generating unit 12 , a queueing device 14, a matching service device 16, a data transmission device 18, and a monitoring station 20.

The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices.

Optical storage devices may include compact-disk read-only memory devices (CD-ROMs) or other types of optical disks. Volatile and non-volatile memory devices include programmable read-only memory (PROM), erasable read-only memory (EPROM), electrically-erasable programmable read-only memory (EEPROM), random-access memory (RAM), static random-access memory (SRAM), dynamic random-access memory (DRAM), magnetic disk drives, tape cartridges, and other types of data storage devices.

Algorithmic instructions that are placed into computer readable media are retrieved and implemented by the processing device. These algorithmic instructions may be accessed through any transmission media that can accommodate the transmission and reception of digital data such as local area networks (LANs), wide area networks (WANS), wireless networks, or the Internet. Those skilled in the art will recognize that modifications may be made to the configurations set forth below without departing from the scope of the present invention, and that the article of manufacture may comprise any medium capable of storing digital information.

The status information generating unit 12 may be either a hardware device or a computer processing device programmed to access the condition of a monitored system 22 such as an information handling system. The computer processing device may be an application-specific integrated circuit (ASIC), a complex programmable-logic device (CPLD), a field-programmable gate array (FPGA), a micro-processor, or other similar device adapted to run software algorithms. The queueing device 14 may also be either a hardware device or a computer processing device programmed to store information. Likewise, the matching service may be performed in either a hardware or computer processing device. The data transmission device 18 is one which communicates with the monitoring station 20 through direct electrical connections, through the use of radio waves, through optical connections, or other communication device known and used in the industry. This includes, but is not limited to, the use of Local Area Networks (LANs), Wide Area Networks (WANs), fiber-optic cable networks, wireless networks, and the Internet.

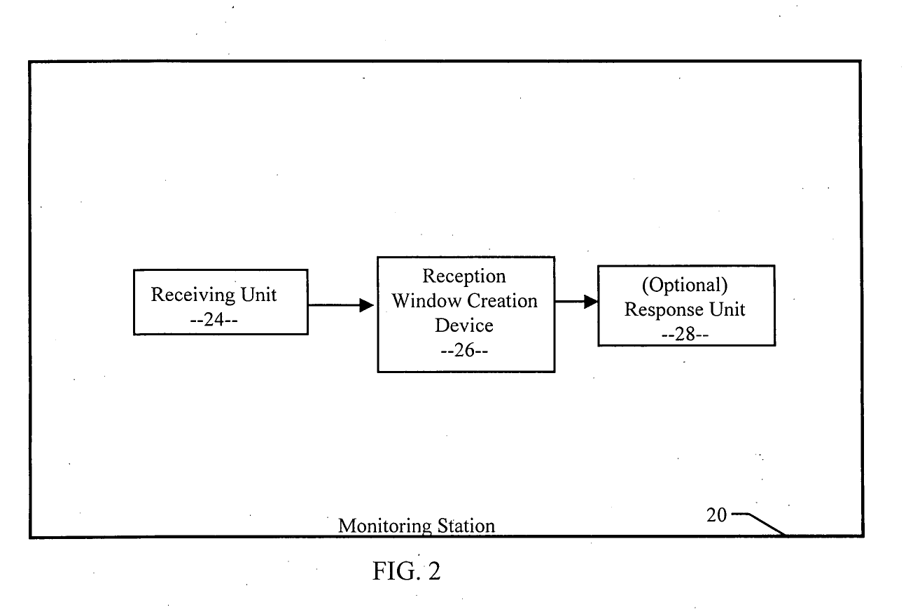

Referring to FIG. 2, a block diagram illustrates the elements of the monitoring station 20. A receiving unit 24 receives information from the data transmission device 18. A reception window creation device 26 is utilized to generate predetermined periods of time corresponding to specific levels of importance or urgency. This reception window creation device 26 may also be programmed within a computer processing device. The invention may optionally include a response unit 28 for directing remedial action in response to received status information containing one or more error messages.

An exemplary implementation of the invention begins with a status information generating unit 12 receiving information from a monitored device. This information could be any datum indicating an operating condition of the monitored device. In this example, the status information is an error message indicating that a problem has occurred in the monitored system 22. The error message is passed to the queueing device where it is compared against a table of information provided by the matching service 16. This table includes a listing of error messages that may require service to the monitored device 22. The listing of error messages may be divided into sets based on how critical the underlying problem is to the operation of the monitored system. Each set of error messages may be associated with a set of reception windows during which the monitoring station 20 may be informed of the problem. In this example, the reception windows correspond to periods of time during which maintenance personnel may be available to repair the monitored system. The listing of error and set of repair windows is defined by a user, usually at the monitoring station 20.

The matching service 16 is responsible for determining if the error message is included in the listing of error messages and whether the current time is within one of the reception windows associated with this particular type of error message. If it is, the error message is transmitted to the monitoring station 20. If the error message is listed but an appropriate reception window is not open, the queueing device 14 stores the information until the current time is within a reception window. If the error message is not in the listing of error messages, then it is discarded. Alternatively, a notification may be sent to the monitoring station or a log may be generated at the monitoring station indicating an unlisted error condition has occurred. A user can review these notifications or logs to determine whether additional error messages should be added to the listing of error messages.

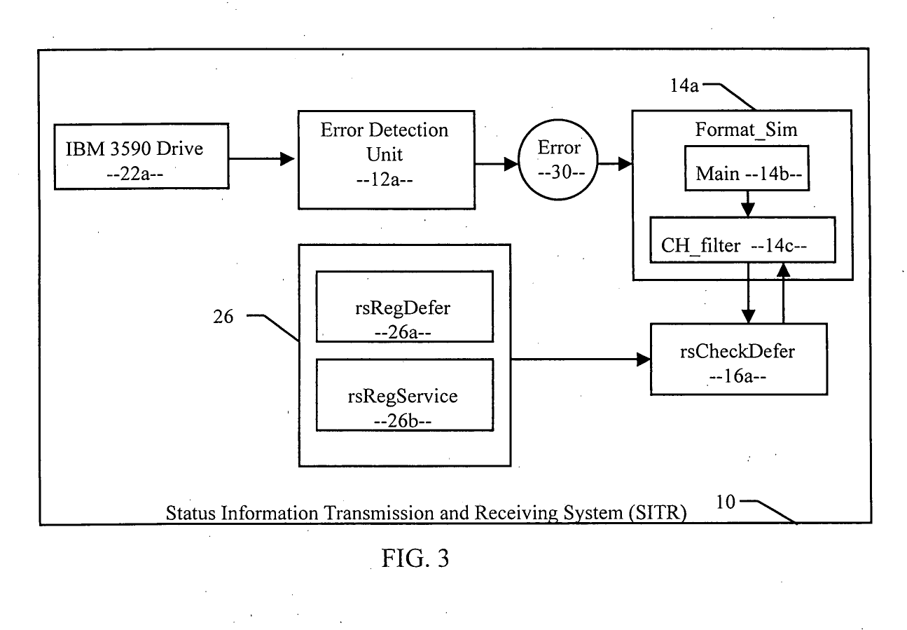

One embodiment of the invention is illustrated in the block drawing of FIG. 3. The purpose of this embodiment is to allow non-acute errors to call home at convenient times, either during normal business hours, or during a pre-determined time interval. The monitored system is an IBM 3590® drive 22a. An error detection unit 12a monitors the 3590 drive and generates an error message 30 if an anomalous condition is observed. A software algorithm referred to as Format_sim 14a is responsible for either queueing the error message or passing it to a monitoring station 20 (FIG. 1). The main program 14b of Format_sim 14a checks for a status return code of “DEFER” from the subroutine CH_filter 14c. The CH_filter subroutine is a simple call to rsCheckDefer 16a that returns either True or False indicating a call home should or should not be deferred, respectively.

The rsCheckDefer program 16a takes input from the CH_filter 14c and determines if this information matches any of the conditions that are defined for a deferred call home. If there is a match, then rsCheckDefer 16a returns True, otherwise False.

The programs rsRegDefer 26a and rsRegService 26b are used to define the reception windows, i.e., the periods of time and conditions during which error messages 30 may be transmitted to the monitoring station 20. RsRegDefer is used to register or alter conditions that cause a deferred call home to occur and the associated service event defining when the current state of the deferred call home becomes active. RsRegService is used to register service events such as a specific day of the week and time or a series of days and times. In this embodiment of the invention, Format_sim 14a assumes the role of the queueing device 14 (FIG. 1), rsCheckDefer acts as the matching service device 16 (FIG. 1), and programs rsRegDefer 26a and rsRegService 26b combine to perform the function of the reception window creation device 26 (FIG. 1). These elements are illustrated as software algorithms that are executed within computer processing devices. These software algorithms may collectively execute within a single processing device or may be dispersed to several disparate processors.

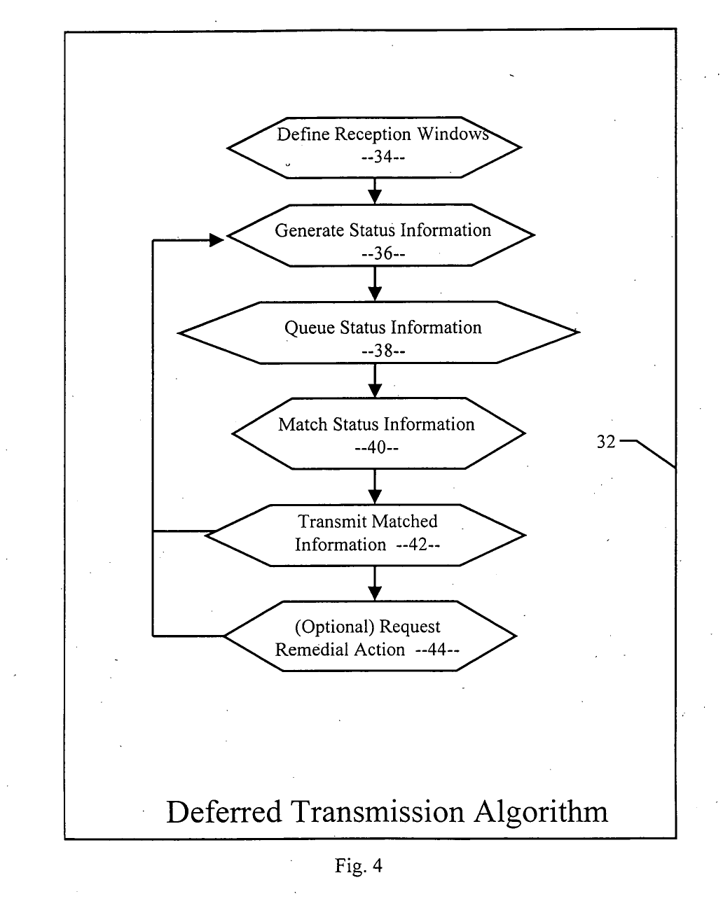

FIG. 4 is a flow-chart illustrating a deferred transmission algorithm 32 including defining reception windows (step 34), generating status information (step 36), queueing status information (step 38), matching status information (step 40) to predefined reception windows, and transmitting matched status information (step 42).

In step 34, a user enters the current date and time and all potential service events into the rsRegService program 26b. In this example of the invention, a separate service event is input for three types of services: (1) one day a week starting at a specified time, (2) weekdays starting at a specified time, and (3) more than one consecutive day starting at a specified time. The user then enters defer conditions into rsRegDefer 26a. As each defer condition is defined, the user selects which service event corresponds to that defer condition.

Step 36 is the generation of an error message by an error detection unit 12a. In step 36, the main program 14b queries the CH_filter subroutine 14c which, in turn, queries the rsCheckDefer program 16a to determine if the error message 30 (FIG. 3) should be queued or transmitted. If the error message is queued, then the rsCheckDefer program 16a determines in step 40 when conditions for transmitting the error message are present and notifies the queueing programs 14a, 14b, 14c that the error message may be transmitted. The error message is subsequently transmitted in step 42. The error message is received at the monitoring station 20 in step 44 and the optional response unit 28 (FIG. 2) dispatches remedial activity in optional step 46.

Those skilled in the art of making status information tracking systems may develop other embodiments of the present invention. For example, the reception window creation device 26 may be implemented in a processing device either on the transmission side of the SITS 10 or at the monitoring station 20.

The terms and expressions which have been employed in the foregoing specification are used herein as terms of description and not of limitation, and there is no intention in the use of such terms and expressions of excluding equivalents of the features shown and described or portions thereof, it being recognized that the scope of the invention is defined and limited only by the claims which follow. Other embodiments of the invention may be implemented by those skilled in the art of tracking status information.

I claim:

1. A status information tracking system, comprising:
a reception-window creation device adapted to establish a criterion associated with a period of time during which status information corresponding to a monitored system may be received by a monitoring station;
a queueing device; and
a status information generating unit adapted to collect said status information from said monitored system and pass the status information to the queueing device;
wherein the queueing device is adapted to determine whether the status information conforms to said specific criterion and, if so, to transmit the status information when a current time is within said period of time.

2. The status information tracking system of claim 1, wherein the queueing device is a data storage device.

3. The status information tracking system of claim 2, wherein the data storage device is a tape cartridge.

4. The status information tracking system of claim 2, wherein the data storage device is a hard-disk drive.

5. The status information tracking system of claim 1, wherein the status information is an error message.

6. The status information tracking system of claim 5, further comprising a response unit and said response unit initiates remedial action to correct a source of the error message.

7. The status information tracking system of claim 6, wherein said remedial action includes dispatching a repair technician.

8. The status information tracking system of claim 7, wherein said period of time coincides with a regularly scheduled maintenance period.

9. The status information tracking system of claim 7, wherein said period of time is intended to be convenient for said repair technician to be dispatched to the source of the error message.

10. A method of tracking status information, comprising the steps of:
establishing a criterion associated with a period of time during which status information corresponding to a monitored system may be received by a monitoring station;
subsequently collecting the status information from the monitored system;
subsequently passing the status information to a queueing device;
subsequently determining whether the status information conforms to said specific criterion; and
if so, transmitting the status information to the monitoring station when a current time is within said period of time.

11. The method of claim 10, further comprising the step of:
prior to said step of transmitting the status information, if the current time is not within the period of time, storing the status information until the current time is within the period of time.

12. The method of claim 11, wherein the status information is an error message.

13. The method of claim 12, further comprising the step of subsequently initiating remedial action to correct a source of the error message.

14. The method of claim 13, wherein said remedial action includes dispatching a repair technician.

15. The method of claim 14, wherein said period of time is intended to be convenient for said repair technician to be dispatched to the source of the error message.

16. An article of manufacture including a data storage medium, said data storage medium including a set of machine-readable instructions that are executable by a processing device to implement an algorithm, said algorithm comprising the steps of:
establishing a criterion associated with a period of time during which status information corresponding to a monitored system may be received by a monitoring station;
subsequently collecting the status information from the monitored system;
subsequently passing the status information to a queueing device;
subsequently determining whether the status information conforms to said specific criterion; and
if so, transmitting the status information to the monitoring station when a current time is within said period of time.

17. The article of manufacture of claim 16, further comprising the step of:
prior to said step of transmitting the status information, if the current time is not within the period of time, storing the status information until the current time is within the period of time.

18. The article of manufacture of claim 17, wherein the status information is an error message.

19. The article of manufacture of claim 18, further comprising the step of subsequently initiating remedial action to correct a source of the error message.

20. The article of manufacture of claim 19, wherein said remedial action includes dispatching a repair technician.
